(19) United States
(12) Patent Application Publication
(10) Pub. No.: US 2016/0097509 A1
(43) Pub. Date: Apr. 7, 2016

(54) LIGHT EMITTING APPARATUS

(71) Applicant: Tanita Corporation, Tokyo (JP)

(72) Inventor: Akihisa HONDA, Tokyo (JP)

(73) Assignee: Tanita Corporation, Tokyo (JP)

(21) Appl. No.: 14/871,264

(22) Filed: Sep. 30, 2015

(30) Foreign Application Priority Data
Oct. 1, 2014 (JP) 2014-202927

(51) Int. Cl. F21V 3/00; F21V 31/00; F21V 15/01; F21V 21/00

(52) U.S. Cl. CPC F21V 3/00; F21V 21/00; F21V 31/00; F21V 15/01; F21Y 2101/02

(57) ABSTRACT

A light emitting apparatus comprises a housing having a light transmitting member provided on a side surface thereof, and at least one light emitting unit housed in the housing.

### CROSS-REFERENCE TO RELATED APPLICATION

This application is based on and claims the benefit of priority of the prior Japanese Patent Application No. 2014-202927, filed on Oct. 1, 2014, the entire contents of which are incorporated herein by reference.

### BACKGROUND OF THE INVENTION

1. Field of the Invention

The present invention relates to a light emitting apparatus.

2. Description of the Related Art

In response to increased health consciousness in recent years, an activity meter has been proposed which can be used by a user to measure the user's activity (exercise) by itself. For example, Japanese Laid-open Patent Publication 2013-215346 describes a portable type activity meter with a display unit. However, the activity meter described in Japanese Laid-open Patent Publication 2013-215346 has a problem that the size of the entire activity meter becomes large, although various information can be displayed on the display unit. It also has a problem that since the display unit and the like are provided on only one side (the upper surface) of the activity meter, the user cannot check and see the displayed content if, for example, the activity meter is placed upside down.

### BRIEF SUMMARY OF THE INVENTION

The present invention has been made in view of the above problems, and an object of the present invention is to provide a light emitting apparatus such as an activity meter which can be reduced in size and is improved in visibility.

According to the present invention, this object is achieved by a light emitting apparatus comprising: a housing having a light transmitting member provided on a side surface thereof; and at least one light emitting unit housed in the housing.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that the drawings are shown for the purpose of illustrating the technical concepts of the present invention or embodiments thereof, wherein:

FIG. 1 is a schematic exploded perspective view for explaining an example of a structure of an activity meter as a light emitting apparatus according to an exemplary embodiment of the present invention;

FIG. 2 is a schematic plan view for explaining an example of a structure of a light transmitting member according to the embodiment of the present invention;

FIG. 3 is a schematic perspective view showing an example of an appearance of the activity meter according to the embodiment of the present invention;

FIG. 4 is a schematic plan view for explaining an example of an inner structure of the activity meter according to the embodiment of the present invention;

FIG. 5 is a schematic cross-sectional view for explaining the example of the inner structure of the activity meter according to the embodiment of the present invention; and

FIG. 6 is a block diagram for explaining an example of an electrical configuration of the activity meter according to the embodiment of the present invention.

### DETAILED DESCRIPTION OF THE INVENTION

Exemplary embodiments of the present invention will be described hereinafter with reference to the drawings. Note that the description will be made in the following order:

<1. EMBODIMENT>; and

<2. MODIFIED EXAMPLE>.

It is to be understood that the embodiments and the like described hereinafter are to illustrate the structures of activity meters as a light emitting apparatus embodying the technical concept of the present invention, but that the present invention is not limited to the illustrated structures. Note that the elements recited in the claims are not limited to the elements described in the embodiments. In particular, the descriptions of, for example, the sizes, materials, shapes and relative arrangements of the constituent elements described in the embodiments as well as directions such as up-down and left-right are not intended to limit the scope of the present invention only to them, and are merely those describing examples, unless an indication of such a limitation is specifically described. Also note that the size, relative position and the like of the elements shown in each drawing may be exaggerated to clarify the description. Further, in the descriptions below, the same names and reference numerals represent the same or similar elements, and duplicate description is omitted as appropriate. Furthermore, regarding the constituents of the light emitting apparatus according to the present invention, a plurality of the constituents can be formed of a single element by allowing the single element to serve as the plurality of the constituents, or on the contrary, the function of a single element can be shared and achieved by a plurality of elements. In addition, the content of a description in a part of examples and embodiments can be applied to other examples, embodiments and the like as appropriate.

### 1. EMBODIMENT

First, a light emitting apparatus according to an exemplary embodiment of the present invention will be briefly described. This embodiment shows an example where the light emitting apparatus according to the present invention is an activity meter. The activity meter comprises a sensor, and calculates an amount of daily activity (calorie consumption, number of steps, and so on) of a user based on sensing data obtained by the sensor. Note that the process of calculating the amount of activity based on the sensing data can be performed by the activity meter, or can be performed by a host device (such as a personal computer and a smart phone) which can communicate with the activity meter. For example, the activity meter is portable, and has a size such that it can be put in a pocket of a bag or clothing. The activity meter does not have, for example, a display unit, and thus can be made small, and therefore the user can use it by easily wearing it on the body or the like. For example, the user can use a wrist band, a string or the like to wear the activity meter on the body like a watch, a necklace or a ring.

The activity meter comprises at least one light emitting unit which is triggered by various actions to allow the light emitting unit to emit light (turn on). The emission mode of the light emitting unit can be set as appropriate. For example, the light emitting unit can be set to emit light only once, or can be set to blink. If the activity meter has a plurality of such light emitting units, the plurality of the light emitting units can be set to emit light all at the same time, or can be set to emit light sequentially. The trigger for the light emitting unit to emit light can be set as appropriate. For example, the light emitting unit can be designed such that when a user performs some operation on the activity meter, the light emitting unit emits light in response to the operation. It can also be designed such that when the amount of activity such as the number of steps exceeds a predetermined level, a number of light emitting units corresponding to the amount of activity emit light. The activity meter briefly described above will be more specifically described below.

### [Example of Structure of Activity Meter]

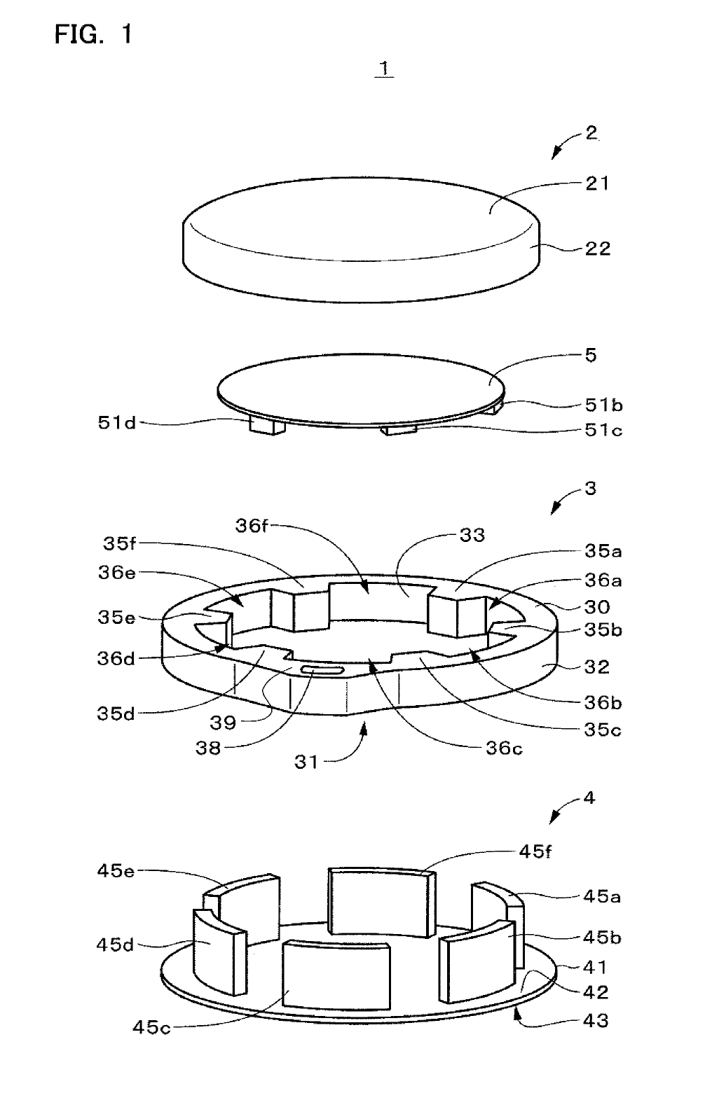

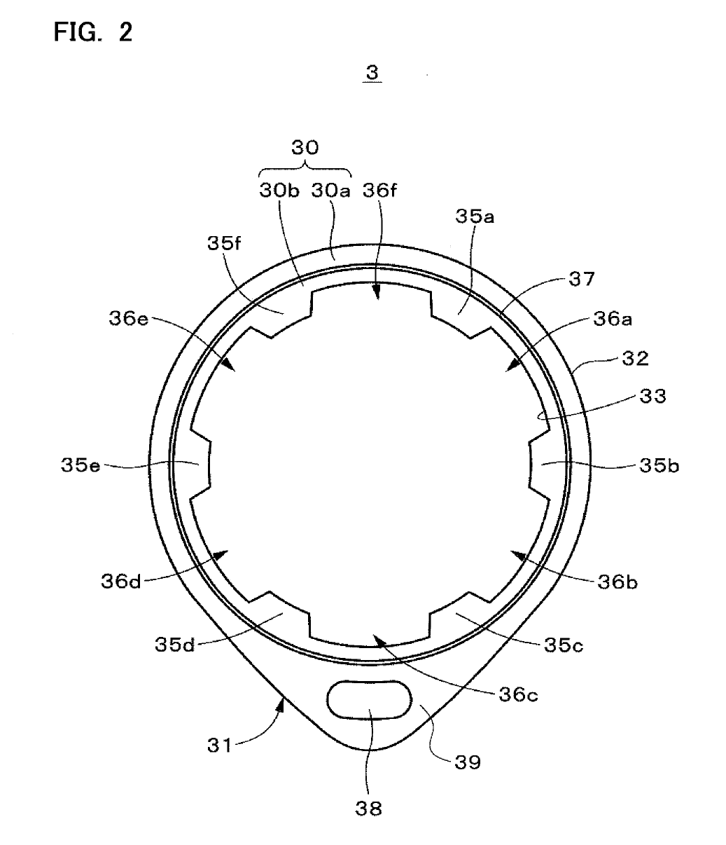

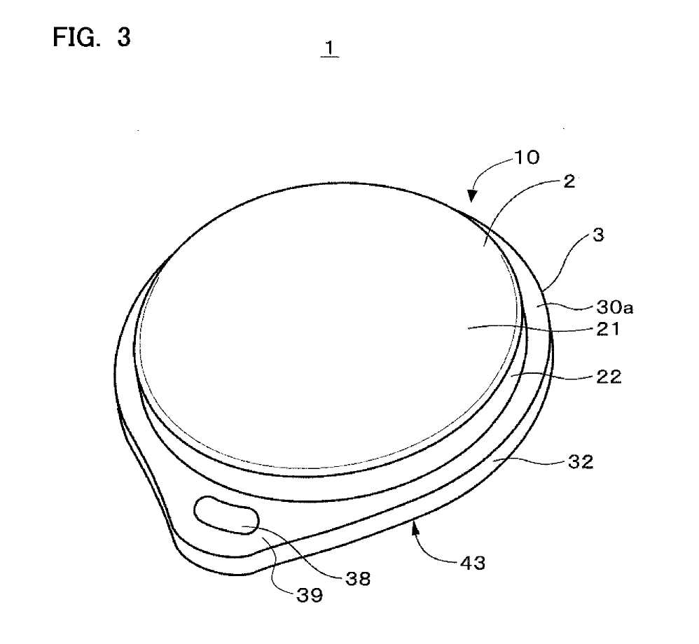

First, referring to FIG. 1 and FIG. 2, an example of a structure of an activity meter 1 as a light emitting apparatus according to an exemplary embodiment of the present invention will be described. FIG. 1 is a schematic exploded perspective view for explaining the example of the structure of the activity meter 1, while FIG. 2 is a schematic plan view for explaining an example of a structure of a light transmitting member 3 of the activity meter 1. The activity meter 1 comprises a housing 10 (refer to FIG. 3) having, for example, a substantially disk shape. The housing 10 of the activity meter 1 is formed, for example, of a top cover 2, the light transmitting member 3 and a bottom cover 4 which are connected to each other. In the following description, one side of the housing 10 facing the center of the housing 10 is defined as inside, while the opposite side is defined as outside. The top cover 2 has an upper surface 21 which is substantially circular shaped and a side surface 22, and also has a space formed therein. As a material for the top cover 2, ABS (Acrylonitrile-Butadiene-Styrene copolymer) resin, an elastomer or the like can be used.

The light transmitting member 3 is a member through which light from at least one LED (Light Emitting Diode) described later, as at least one light emitting unit, passes. A silicone rubber, an acrylic resin or the like can be used as a material for the light transmitting member 3. If a silicone rubber is used, it is possible to allow the light transmitting member 3 to function not only as a member through which light passes, but also as a water proof member. In this case, it can be said that the light transmitting member 3 comprises a water proof member. This makes it possible to eliminate the need for a structure such as a water proof packing, making it possible to reduce the number of components and reduce the manufacturing cost. Note that the light transmitting member 3 is not limited to a transparent or translucent one, and further the light transmitting member 3 can be colored.

As shown in FIG. 1 and FIG. 2, the light transmitting member 3 of the present embodiment is substantially ring-shaped, and has an upper surface 30, a bottom surface 31, an outer peripheral surface (side surface) 32 and an inner peripheral surface 33. The upper surface 30 comprises a first upper surface 30a located outside and a second upper surface 30b located inside to form a two-level structure in which the second upper surface 30b is slightly recessed from the first upper surface 30a. An inclined portion 37 is formed between the first upper surface 30a and the second upper surface 30b. Note that in order to prevent the drawing from being complicated, the illustration of the inclined portion 37 is omitted in FIG. 1. The radial length of the light transmitting member 3 (length from the center to the side surface 32) is set to be slightly larger than the radial length of the upper surface 21 of the top cover 2.

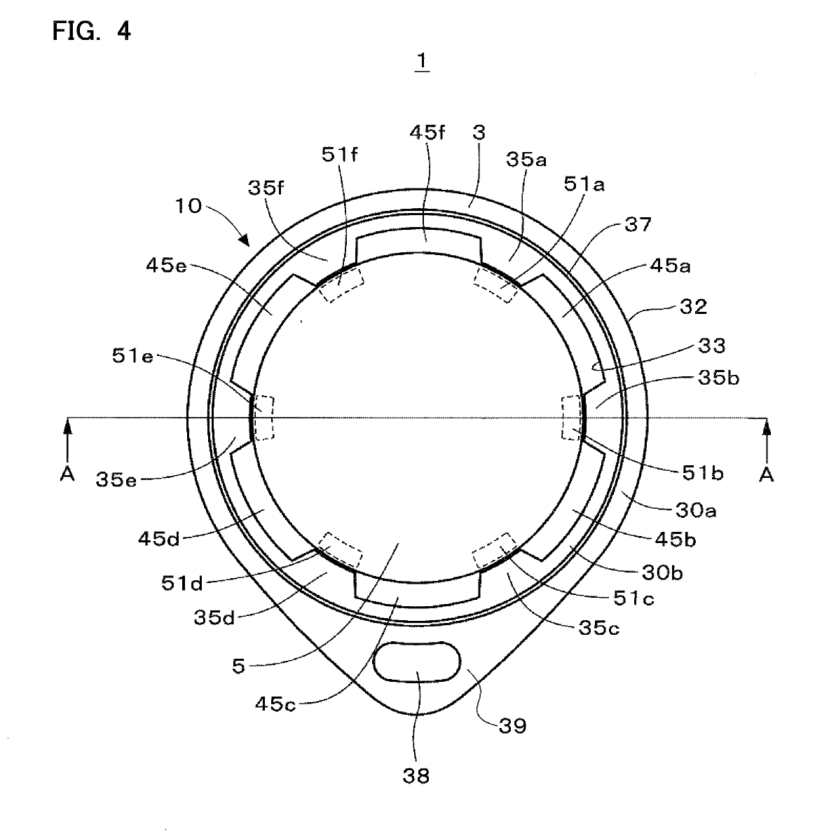

At least one projection corresponding to at least one light emitting unit is provided on the inner peripheral surface 33 of the light transmitting member 3. In the present embodiment, a plurality of projections are provided on the inner peripheral surface 33 of the light transmitting member 3. More specifically, a number of projections corresponding to the number of light emitting units each comprising an LED described later are provided on the inner peripheral surface 33 of the light transmitting member 3. In the present embodiment, as an example, six projections (projection 35a, projection 35b, projection 35c, projection 35d, projection 35e and projection 35f) are provided to be spaced from each other. If there is no need to distinguish between the individual projections, they are collectively referred to as projections 35. For example, each of the projections 35 is shaped to increase in width from inside to outside of the light transmitting member 3 or of the housing 10 shown in FIG. 4.

A gap is formed between each pair of the adjacent projections 35. More specifically, a gap 36a is formed between the projection 35a and the projection 35b. A gap 36b is formed between the projection 35b and the projection 35c. A gap 36c is formed between the projection 35c and the projection 35d. A gap 36d is formed between the projection 35d and the projection 35e. A gap 36e is formed between the projection 35e and the projection 35f Further, a gap 36f is formed between the projection 35f and the projection 35a. If there is no need to distinguish between the individual gaps, they are collectively referred to as gaps 36. The gaps 36 are provided with wall portions 45 of the bottom cover 4 as described later. The light transmitting member 3 has a projection 39 which extends outwardly, and which has formed therein a through-hole 38 extending vertically therethrough. By inserting a string, a strap or the like through the through-hole 38, the user can wear the activity meter 1 on the body like a necklace, an arm ring or the like.

The bottom cover 4 comprises a substantially circular base 41. The radial length of the base 41 is set to be slightly smaller than the radial length of the light transmitting member 3. The base 41 has an upper surface 42 and a bottom surface 43. A plurality of wall portions are provided to stand on the upper surface 42 of the base 41. The number of the provided wall portions corresponds to the number of gaps 36 of the light transmitting member 3. In the present embodiment, as an example, six wall portions (wall portion 45a, wall portion 45b, wall portion 45c, wall portion 45d, wall portion 45e and wall portion 45f) are provided. If there is no need to distinguish between the individual wall portions, they are collectively referred to as wall portions 45. The wall portions 45 are located slightly inside the peripheral edge of the upper surface 42, and are provided at locations spaced from each other on a virtual circle on the upper surface 42. For example, each of the wall portions 45 has a slightly curved shape as a whole, and has a height which is set to be slightly larger than the thickness of the light transmitting member 3. The size of the space between each pair of the adjacent wall portions 45 is set such that each of the projections 35 of the light transmitting member 3 can be inserted through the space.

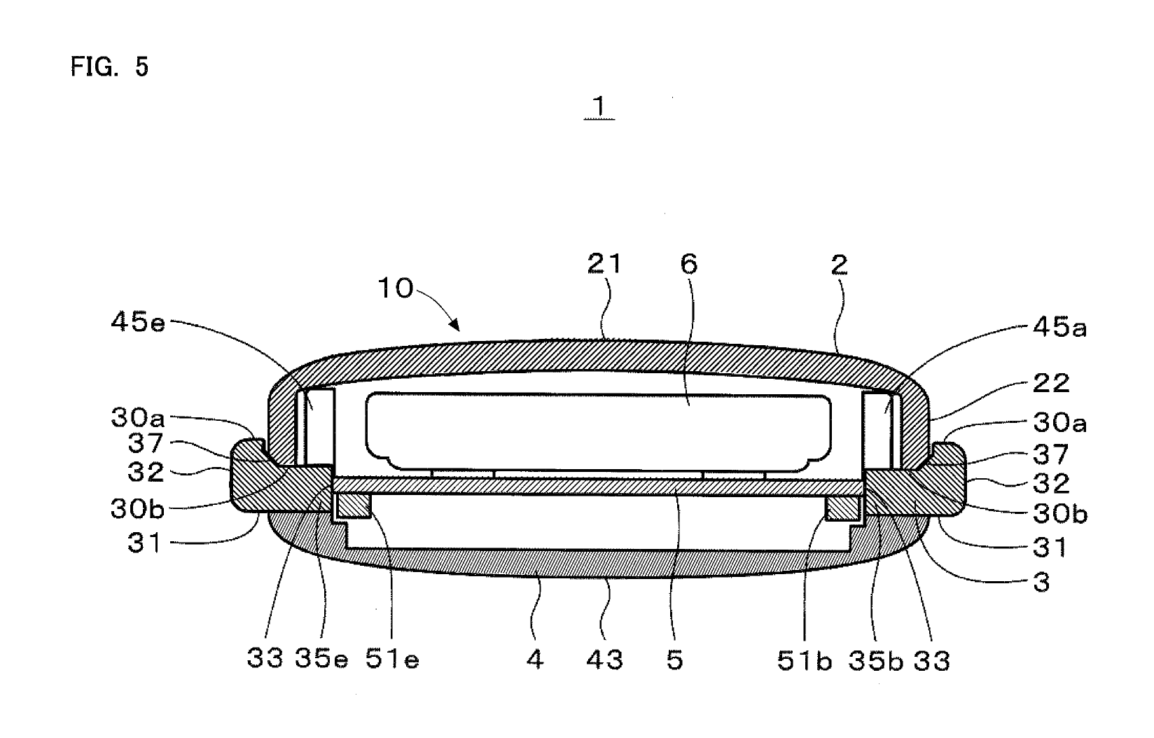

A substrate 5 and a battery (omitted from the illustration in FIGS. 1 and 2 and shown as battery 6 in FIG. 5) are housed in the activity meter 1. The substrate 5 has, for example, a substantially circular shape, and its size is set such that it can be housed inside the light transmitting member 3. The substrate 5 has at least one light emitting unit (one or a plurality of light emitting units) connected to a bottom surface thereof near the periphery thereof. An LED is used as each of the light emitting units. For example, in the present embodiment, six LEDs (LED 51a, LED 51b, LED 51c, LED 51d, LED 51e and LED 51f), as six light emitting units, are connected to a bottom surface of and near the periphery of the substrate 5, and are spaced from each other at predetermined intervals. For example, the LEDs are provided at locations spaced from each other on a virtual circle in the housing 10 of the activity meter 1. If there is no need to distinguish between the individual LEDs, they are collectively referred to as LEDs 51.

The substrate 5 has further mounted thereon a control circuit to control emission of the at least one light emitting unit (at least one LED 51), a communication module for the activity meter 1 to communicate with external or other electronic devices, and the like. The illustration of the control circuit, the communication module and the like are omitted in the drawing. Note that the shape of the substrate 5 and the locations where the LEDs 51 are connected as described above are examples and are not limited thereto. For example, each of the LEDs 51 is formed as a two-color LED (two-chip LED) comprising a red LED chip and a green LED chip. Each of the LEDs 51 can also be, for example, a three-color LED further comprising a blue LED chip. Further, it is not necessary that all the LEDs 51 have the same color. For example, the LED 51a and the LED 51b can be structured to emit different colors. An appropriate shape such as a bullet shape, a cylindrical shape, a cubic shape or the like can be used for each of the LEDs 51. Light from LEDs 51 is diffused by the light transmitting member 3.

The activity meter 1 is assembled and integrally formed, for example, as follows. The light transmitting member 3 is attached to the bottom cover 4 such that the wall portions 45 are inserted into the gaps 36 of the light transmitting member 3. More specifically, the light transmitting member 3 is attached to the bottom cover 4 such that the wall portion 45a, the wall portion 45b, the wall portion 45c, the wall portion 45d, the wall portion 45e and the wall portion 45f are inserted into the gap 36a, the gap 36b, the gap 36c, the gap 36d, the gap 36e and the gap 36f, respectively. At this time, the projections 35 of the light transmitting member 3 are respectively located in the spaces between the wall portions 45. The bottom surface 31 of the light transmitting member 3 is in contact with the upper surface 42 of the bottom cover 4. Then, the substrate 5 and the like are housed inside the light transmitting member 3, and thereafter the top cover 2 is attached thereto. The top cover 2 has a bottom surface supported on the second upper surface 30b of the light transmitting member 3. Note that in order to make the battery replaceable, the activity meter 1 is designed such that the top cover 2 can be detached from the activity meter 1. The illustration of a structure which enables the top cover 2 to be attached and detached to and from the activity meter 1 is omitted in the drawing.

FIG. 3 is a schematic perspective view showing an example of an appearance of the activity meter 1. The activity meter 1 has an appearance which is substantially disk shaped as a whole. As apparent from the above description, the activity meter 1 comprises the housing 10 comprising an upper surface, a bottom surface and a side surface. The upper surface of the housing 10 corresponds, for example, to the upper surface 21 of the top cover 2, while the bottom surface of the housing 10 corresponds, for example, to the bottom surface 43 of the bottom cover 4. Note that when the activity meter 1 is used, it is not always necessary for the bottom surface 43 of the bottom cover 4 to be positioned to face downward. Depending on the way of using the activity meter 1 (for example, when the activity meter 1 is used by hanging it like a necklace), the upper surface 21 of the top cover 2 may not be positioned to face upward. Thus, the terms such as upper surface, bottom surface and the like are used for convenience of description, and do not limit the interpretation of the structure, the way of use, and the like of the activity meter 1.

The housing 10 of the activity meter 1 has a side surface comprising at least a first side surface and a second side surface located at an outer position than the first side surface relative to the housing 10. The first side surface corresponds, for example, to the side surface 22 of the top cover 2. For example, the second side surface corresponds to the side surface 32 of the light transmitting member 3. In other words, the activity meter 1 has the light transmitting member 3 arranged on at least a part of the side surface thereof, and more specifically, the activity meter 1 is shaped such that the periphery and its vicinity of the light transmitting member 3 project outward. Note that in this embodiment, the periphery and its vicinity of the light transmitting member 3 are shaped to project outward as a preferred mode of the present invention. However, a shape in which they do not project, in other words, a shape in which the first side surface and the second side surface are in the same plane, is not excluded from the present invention.

When the activity meter 1 is seen from directly above, the first upper surface 30a of the light transmitting member 3 is visible. When the activity meter 1 is seen directly from the side, the side surface 32 of the light transmitting member 3 is visible. When the activity meter 1 is seen from directly below, a rear surface of the light transmitting member 3 opposite to the first upper surface 30a is visible. When the activity meter 1 is seen diagonally, the first upper surface 30a (or the rear surface) and the side surface 32 are visible. Thus, regardless of the direction in which the activity meter 1 is seen, at least a part of the light transmitting member 3 can be seen and checked. Therefore, when the LEDs 51 emit light, the user can check the light from the LEDs 51 which passes through the light transmitting member 3, making it possible to improve the visibility of the LEDs 51. Since the light transmitting member 3 passes the light from the LEDs 51 vertically and horizontally, the user can check the light from the LEDs 51 even if the user uses the activity meter 1 by placing it upside down or by hanging it.

Note that even when the periphery and its vicinity of the light transmitting member 3 are shaped not to project outward as described above, the activity meter 1 can improve the visibility of the LEDs 51, compared to the conventional activity meter described in Japanese Laid-open Patent Publication 2013-215346 in which the display unit is provided on only the upper surface. Particularly, as long as the activity meter 1 comprises the housing 10 having the light transmitting member 3 provided on the side surface thereof, and at least one light emitting unit (LED 51) housed in the housing 10, the activity meter 1 can increase the possibility that the user can see and check the light from the at least one light emitting unit (LED 51), even if the user uses the activity meter 1 by placing it upside down or by hanging it, compared to the above-described conventional activity meter.

Referring to FIG. 4 and FIG. 5, an example of an inner structure of the activity meter 1 will be described. FIG. 4 is a schematic plan view showing the example of the inner structure of the activity meter 1 as seen from above the activity meter 1. Note that in FIG. 4, the illustration of the top cover 2 is omitted to describe the example of the inner structure. FIG. 5 is a schematic cross-sectional view of the activity meter 1 cut along the line A-A of FIG. 4. Note that in FIG. 5, hatching indicating the cross-sectional of a battery 6 and its neighboring elements is omitted, and a part of the drawing is simplified as appropriate.

The bottom cover 4 is attached to the light transmitting member 3 such that the wall portions 45 of the bottom cover 4 are inserted into the gaps 36 of the light transmitting member 3. The substrate 5 is housed inside the light transmitting member 3. The at least one light emitting unit faces the at least one projection 35 with a space therebetween. In FIG. 4, each of the LEDs 51 connected to the substrate 5 is shown by a dashed rectangle. Each of the LEDs 51 faces each of the projections 35 with a space therebetween. For example, the LED 51b faces the projection 35b with a space therebetween. Light emitted from the LED 51b passes through the projection 35b, and passes through inside the light transmitting member 3, and is diffused therein. Here, the projection 35b in the embodiment is shaped to increase in width as it gets farther from the light source (LED 51b). Thus, the light from the LED 51b can be diffused. In this mode, the entire light transmitting member 3 emits light due to the light from the LEDs 51 including the LED 51b.

Further, in the embodiment of the present invention, the inclined portion 37 inclined and extending from the second upper surface 30b to the first upper surface 30a is provided in the light transmitting member 3. The inclined portion 37 can guide the light from the LED 51b (LEDs 51) to the first upper surface 30a, making it possible to further diffuse the light from the LED 51b (LEDs 51). Note that the light from the LEDs 51 can be further diffused by adding a known light diffusing agent to the light transmitting member 3. Also note that the light from the LED 51b may be attenuated due to the space (air layer) between the LED 51b and the projection 35b. Thus, it is desirable that such a space (air layer) is made as small as possible. Such a space can be 0, or in other words, the LED 51b can be in contact with the projection 35b. The combination of the LED 51b and the projection 35b has been described as an example, but this also applies to the other combinations of the LEDs and the projections. Thus, it can be said that the at least one light emitting unit can be in contact with the at least one projection 35. Further note that FIG. 5 shows, for example, a structure in which the LED 51b faces a lower part of the inner peripheral surface 33 of the light transmitting member 3, but the present invention is not limited to such a structure. In order for more of the light from the LED 51b to pass through the light transmitting member 3, it is desirable that the LED 51b faces or is in contact with a vertically central part of the inner peripheral surface 33. This also applies to the other LEDs.

It is to be noted here that if the activity meter is designed to allow light from the LEDs to pass only toward the side of one surface (for example, the upper surface) thereof, the light transmitting member of the activity meter is required to have a projection or the like in the direction of height or thickness thereof in order to increase the light emitting area, thereby causing a problem that the thickness of the entire activity meter increases. In contrast, the present embodiment provides the light transmitting member 3 including the projections 35 in the horizontal direction relative to the LEDs 51. Thus, the thickness of the activity meter 1 can be prevented from increasing, making it possible to prevent the activity meter 1 from being bulky when the user wears the activity meter 1 on the body or puts it in a pocket or the like. In other words, the activity meter 1 according to the present embodiment can be reduced in size by providing the light transmitting member 3 on a side surface of the housing 10 (which corresponds to the above-described second side surface, which in turn corresponds to the side surface 32 of the light transmitting member 3).

As shown in FIG. 5, the substrate 5 and the battery 6 are housed in the housing 10 of the activity meter 1. More specifically, the substrate 5 and the battery 6 are held by a holding member (not shown) in a predetermined position in the housing 10. The substrate 5 is electrically connected to the battery 6 so as to supply power of the battery 6 to the control circuit and the like of the substrate 5. The battery 6 is, for example, a coin type primary battery. Of course, the shape of the battery 6 is not limited to the coin type. The battery 6 can be a rechargeable secondary battery, a capacitor or the like. Note that although the activity meter 1 houses therein not only the substrate 5 and the battery 6, but also other elements (such as a sensor described later), the illustration of them is omitted in the drawing as appropriate.

### [Electrical Configuration of Activity Meter]

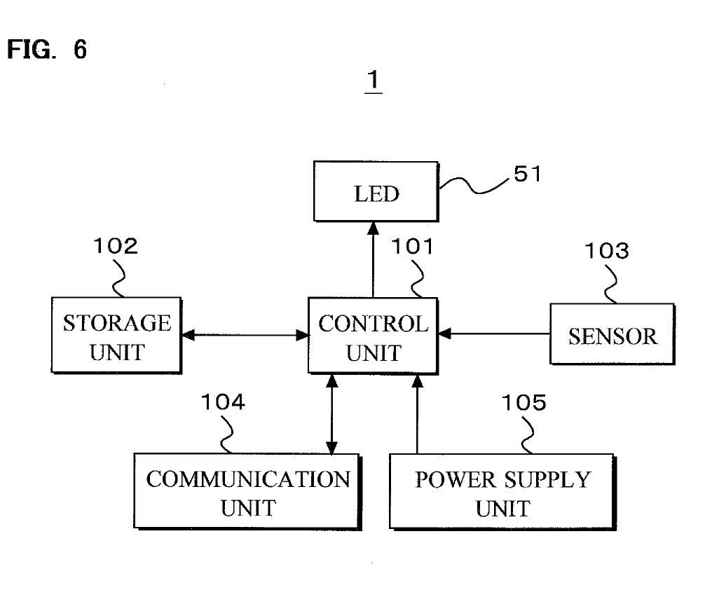

FIG. 6 is a block diagram for explaining an electrical configuration of the activity meter 1. For example, the activity meter 1 comprises a control unit 101, a storage unit 102, a sensor 103, a communication unit 104 and a power supply unit 105 in addition to the LEDs 51. The power supply unit 105 is, for example, the battery 6 described above. Since the LEDs 51 have already been described, duplicate description is omitted. For example, the control unit 101 comprises a CPU (Central Processing Unit) to control the respective units of the activity meter 1. More specifically, the control unit 101 supplies sensing data obtained by the sensor 103 to the communication unit 104, and controls the communication unit 104 to transmit the sensing data to an external device. Further, the control unit 101 performs a process of writing and reading data to and from the storage unit 102. In addition, the control unit 101 controls light emission to turn the LEDs 51 on and off. The control unit 101 can also be designed to perform processes other than those exemplified above. It is also possible to allow the control unit 101 to have a timing function and an A/D (Analog to Digital) conversion function.

The storage unit 102 comprises, for example, a ROM (Read Only Memory) and a RAM (Random Access Memory). For example, the ROM stores a program to be executed by the control unit 101. The RAM is used as a work area when the control unit 101 performs a process. Note that the storage unit 102 can be designed to be attachable to and detachable from the activity meter 1. The sensor 103 comprises, for example, a three-axis acceleration sensor. For example, the sensor 103 detects a movement of a user wearing the activity meter 1, and outputs sensing data corresponding to the movement of the user. The sensing data output from the sensor 103 is supplied to the control unit 101. Note that the sensor 103 can comprise a plurality of sensors.

The communication unit 104 is a unit to perform wireless communication with external or other electronic devices based on a predetermined communication standard. Examples of communications based on the predetermined standard are an infrared-based communication, a communication based on the “Zigbee (registered trademark)” standard, a communication based on the “Bluetooth (registered trademark)” standard, a communication based on the “Wi-Fi (registered trademark)” standard which makes it possible to easily build a network, and the like, but are not limited thereto. Note that the communication unit 104 can be designed to perform short-range wireless communication based on the NFC (Near Field Communication) standard. The use of wireless communication based on the NFC standard makes it possible to establish a connection (pairing) between the activity meter 1 and an external or another electronic device (such as a smart phone) just by holding the activity meter 1 over the external electronic device. The activity meter 1 can also be designed to send and receive data to and from an external electronic device by performing high quality communication based on, for example, the Bluetooth standard after establishing the connection using wireless communication based on the NFC standard. Also note that the activity meter 1 can be designed to send and receive data to and from an external electronic device through a (NFC) reader/writer.

### [Operation of Activity Meter]

An example of an operation of the activity meter 1 will be briefly described. The sensor 103 outputs sensing data corresponding to a movement of the user wearing the activity meter 1. The sensing data is supplied to the control unit 101. The control unit 101 stores the sensing data input from the sensor 103 in the storage unit 102. For example, when a connection between the activity meter 1 and an external or another electronic device is established, the controller 101 reads the sensing data from the storage unit 102, and controls the communication unit 104. The communication unit 104 operates under the control of the control unit 101, and transmits the sensing data from the activity meter 1 to the external electronic device. Based on the sensing data transmitted from the activity meter 1, the external electronic device performs a predetermined calculation to obtain an amount of activity of the user such as calorie consumption, number of steps, and so on. The amount of activity is presented to the user on a display or the like. Note that the control unit 101 can also be designed to perform a calculation based on the sensing data to obtain the amount of activity of the user.

The control unit 101 performs a control to allow the LEDs 51 to emit light at an appropriate timing. For example, the control unit 101 allows the LEDs 51 to emit light at a timing when the sensing data is input from the sensor 103. In this case, the control unit 101 can be designed to allow an increased number of LEDs 51 to emit light as the magnitude (voltage value) of the sensing data increases. The control unit 101 can also be designed to allow the LEDs 51 to emit light in a predetermined light emission mode while performing a pairing process. The control unit 101 can further be designed to allow the LEDs 51 to emit light when the residual capacity of the battery 6 (power supply unit 105) becomes lower than a predetermined value.

As described above, the user can at least recognize that the activity meter 1 is emitting light regardless of the direction in which the activity meter 1 is seen, namely, regardless of how the activity meter 1 is placed or attached. By checking the light emission mode in more detail, the user recognizing the light emission can understand what kind of information is provided. The activity meter 1 is operated, for example, by tapping the upper surface 21 of the top cover 2 a predetermined number of times. The sensor 103 obtains sensing data corresponding to the number of times of tapping, and the obtained sensing data is supplied to the control unit 101. The control unit 101 analyzes the sensing data input thereto to calculate the number of operations (tapping), and performs a control corresponding to the number of operations. It is possible to appropriately set the association between the number of tapping and a function performed thereby.

### 2. MODIFIED EXAMPLE

In the foregoing, an exemplary embodiment of the present invention has been described. However, the present invention is not limited to the embodiment described above, and various modifications are possible within the scope of the present invention. A modified example of the present invention will be described as follows. The above-described exemplary embodiment shows an example where the light emitting apparatus according to the present invention is the activity meter. However, the light emitting apparatus is not limited to the activity meter, but can be other types of devices. Additionally, the structure of the housing 10 of the activity meter 1 is not limited to the structure described in the above embodiment. For example, the light transmitting member 3 and the bottom cover 4 can be integrally formed by two-layer molding or the like. Further, the activity meter 1 can be designed to be provided with a speaker or a vibration motor for the activity meter 1 to reproduce sound or vibrate. The communication between the activity meter 1 and other external electronic devices can be done not only via wireless connection but also via wired connection.

It is to be noted that the present invention is not limited to the above-described embodiment and the modified example, and various modifications are possible within the spirit and scope of the present invention. The present invention has been described above using the exemplary embodiment and the modified example, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

1. A light emitting apparatus comprising:
a housing having a light transmitting member provided on a side surface thereof; and
at least one light emitting unit housed in the housing.

2. The light emitting apparatus according to claim 1,
wherein the side surface of the housing comprises at least a first side surface and a second side surface located at an outer position than the first side surface relative to the housing, and
wherein the light transmitting member has a side surface which corresponds to the second side surface.

3. The light emitting apparatus according to claim 1,
wherein at least one projection is provided on an inner peripheral surface of the light transmitting member, and
wherein the at least one projection faces the at least one light emitting unit with a space therebetween, or is in contact with the at least one light emitting unit.

4. The light emitting apparatus according to claim 3,
wherein the at least one projection is shaped to increase in width from inside to outside of the housing.

5. The light emitting apparatus according to claim 1,
wherein the light transmitting member is substantially ring-shaped.

6. The light emitting apparatus according to claim 1,
wherein the at least one light emitting unit comprises a plurality of light emitting units each comprising a light emitting diode, and
wherein the plurality of light emitting diodes are spaced from each other on a vertical circle inside the housing.

7. The light emitting apparatus according to claim 1,
wherein the light transmitting member comprises a water proof member.
